(19) United States
(12) Patent Application Publication
(10) Pub. No.: US 2017/0155740 A1
(43) Pub. Date: Jun. 1, 2017

(54) Method, Electronic Device and System for Acquiring Video Data

(71) Applicants: Le Holdings (Beijing) Co., Ltd., Beijjing (CN); LeCloud Computing Co., Ltd., Beijing (CN)

(72) Inventors: Fengyu Liu, Beijing (CN); Fenng Han, Beijing (CN); Chao Li, Beijing (CN); Yangang Xia, Beijing (CN)

(21) Appl. No.: 15/246,422

(22) Filed: Aug. 24, 2016

Related U.S. Application Data
(63) Continuation of application No. PCT/CN2016/088873, filed on Jul. 6, 2016.

(30) Foreign Application Priority Data
Dec. 1, 2015 (CN) 201510866424.0

(51) Int. Cl. H04L 29/08

(52) U.S. Cl. CPC H04L 67/327; H04L 67/1097; H04L 67/42

(57) ABSTRACT

Disclosed are a method, an electronic device and a system for acquiring video data. The method includes: first of all, receiving, by a content distribution network (CDN) server, an acquisition request of a video source server access path sent by a client; then sending the acquisition request to a scheduling server so that the scheduling server acquires access path information corresponding to the acquisition request; then receiving the access path information sent by the scheduling server; and at last acquiring and sending video data in the video source server to the client according to the access path information.

### CROSS REFERENCE TO RELATED APPLICATIONS

This application is a continuation of International Application No. PCT/CN2016/088873, filed on Jul. 6, 2016, which is based upon and claims priority to Chinese Patent Application No. 201510866424.0, filed on Dec. 1, 2015, the entire contents of all of which are incorporated herein by reference.

### TECHNICAL FIELD

The present disclosure relates to video technologies, and more particularly, to a method, an electronic device and a system for acquiring video data.

### BACKGROUND

In recent years, with the rise of the network, videos having been downloaded locally can be played by video players, furthermore, videos can be downloaded and played simultaneously by connecting video players to a cloud live broadcasting server providing videos, thereby implementing online real-time playback of videos.

At present, in an existing cloud live video broadcasting system, when a user needs to watch a live video, an acquisition request of an access path of a video source server may be sent to a scheduling server by means of a client of a video player, and video data in the video source server may be acquired according to the obtained access path.

However, the access path obtained through the above mentioned way includes address information of a video source server, for example, an IP address of the video source server. Consequently, a potential safety hazard may be caused to the video source server if the access path is sent to a client, thereby having a negative effect on security of the video source server.

### SUMMARY

The present disclosure provides a method, an electronic device and a system for acquiring video data to solve a problem that a potential safety hazard may be caused to a video source server in the prior art.

In a first aspect, embodiments of the present disclosure provide a method for acquiring video data, implemented by a content distribution network (CDN) server, including:

receiving, by a CDN server, an acquisition request of a video source server access path sent by a client;

sending the acquisition request to a scheduling server so that the scheduling server acquires access path information corresponding to the acquisition request;

receiving the access path information sent by the scheduling server; and

acquiring and sending video data in the video source server to the client according to the access path information.

In a second aspect, embodiments of the present disclosure provide a non-transitory computer-readable storage medium storing executable instructions, wherein the executable instructions are configured to perform any methods for acquiring video data mentioned by embodiments of the present disclosure.

In a third aspect, embodiments of the present disclosure provide an electronic device, including: at least one processor; and a memory communicably connected with the at least one processor for storing instructions executable by the at least one processor, wherein execution of the instructions by the at least one processor causes the at least one processor to perform any methods for acquiring video data mentioned by embodiments of the present disclosure.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flow chart of a method for acquiring video data in accordance with some embodiments;

FIG. 2 is a flow chart of another method for acquiring video data in accordance with some embodiments;

FIG. 3 is a flow chart of still another method for acquiring video data in accordance with some embodiments;

FIG. 4 is a flow chart of still another method for acquiring video data in accordance with some embodiments;

FIG. 5 is a schematic structural diagram of a CDN server in accordance with some embodiments;

FIG. 6 is a schematic structural diagram of another CDN server in accordance with some embodiments;

FIG. 7 is a schematic structural diagram of a client in accordance with some embodiments;

FIG. 8 is a schematic structural diagram of a client in accordance with some embodiments;

FIG. 9 is a schematic structural diagram of a system for acquiring video data in accordance with some embodiments;

FIG. 10 is a schematic diagram of an entity structure of a CDN server in accordance with some embodiments; and

FIG. 11 is a block diagram of an electronic device which is configured to perform the methods for acquiring video data in accordance with some embodiments.

### DETAILED DESCRIPTION

To make the objectives, technical solutions, and advantages of the embodiments of the present disclosure clearer, the following clearly and completely describes the technical solutions in the embodiments of the present disclosure with combination of the accompanying drawings in the embodiments of the present disclosure. Apparently, the described embodiments are some but not all of the embodiments of the present disclosure.

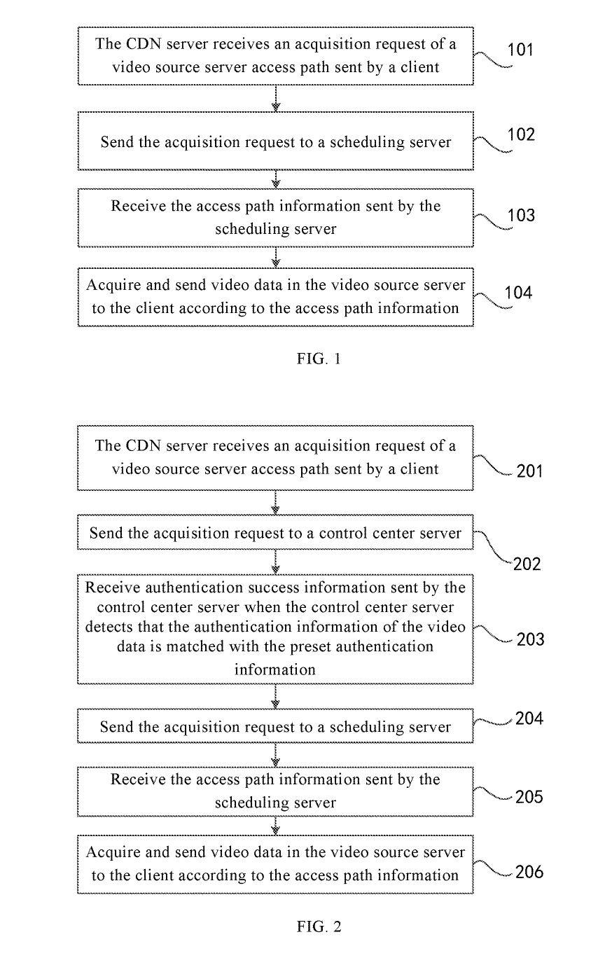

Embodiments of the present disclosure provide a method for acquiring video data, which can be applied to a CDN server, as shown in FIG. 1, the method includes following steps.

101: The CDN server receives an acquisition request of a video source server access path sent by a client.

The acquisition request is used for acquiring an access path of a video source server. The video source server saves video data required to be acquired for the client. The CDN server is an edge CDN server in a content distribution network. As a new-type network content service system, the CDN is constructed based on an IP network and provides content distribution and a service based on efficiency requirements, quality requirements and content orders of content-based accesses and applications. In a broad sense, the CDN represents a high-quality and high-efficiency network application service mode having a distinct network order that is constructed based on a network.

102: The acquisition request is sent to a scheduling server.

Further, the scheduling server is allowed to acquire access path information corresponding to the acquisition request. The scheduling server saves access paths of different video source servers. The access path information includes an access path of the video source server.

103: The access path information sent by the scheduling server is received.

104: Video data in the video source server are acquired and sent to the client according to the access path information.

To the embodiments of the present disclosure, video streaming media data in the video source server are acquired according to the received access path information and sent to the client so that the client can play the video streaming media data.

According to a method for acquiring video data provided by embodiments of the present disclosure, an acquisition request of a video source server access path sent to a scheduling server by a client is forwarded by means of a CDN server, and video data in a video source server are acquired and sent to the client at the CDN server according to access path information. Compared with a fact that at present access path information is sent to a client to acquire video data, in the present disclosure, the access path information is saved and invoked at the CDN server, which can better ensure security of address information of the video source server so that the address information of the video source server is not easily wiretapped by a Trojan horse, a third-party application or the like, thereby reducing a potential safety hazard caused to the video source server.

Embodiments of the present disclosure provide another method for acquiring video data, which can be applied to a CDN server, as shown in FIG. 2, the method includes following steps.

201: The CDN server receives an acquisition request of a video source server access path sent by a client.

To the embodiments of the present disclosure, the Step 201 specifically can include: a CDN server receives an acquisition request of a video source server access path sent by a DNS (Domain Name System) domain name server corresponding to a client, where reference can be made to corresponding description of Step 101 for an explanation of the concept of the CDN server, which is not unnecessarily elaborated any more herein. The DNS domain name server is configured to receive the acquisition request sent by the client and configure the CDN server corresponding to the client. It is to be noted that the DNS domain name server can obtain an Internet Protocol (IP) address corresponding to the client by resolving the received acquisition request, then determine a CDN server the closest to the IP address corresponding to the client, and send the acquisition request to the CDN server the closest to the IP address.

202: The acquisition request is sent to a control center server.

Further, the control center server is allowed to detect whether authentication information of the video data is matched with preset authentication information. The acquisition request includes authentication information of video data. The authentication information includes authentication information such as a domain name, a secret key and so on, which is used for authenticating whether the client has a right to acquire access path information of the video data. The preset authentication information can be configured according to actual demands to verify authentication information.

203: Authentication success information sent by the control center server is received when the control center server detects that the authentication information of the video data is matched with the preset authentication information.

204: The acquisition request is sent to a scheduling server.

Further, the scheduling server is allowed to acquire access path information corresponding to the acquisition request. The scheduling server saves access paths of different video source servers. The access path information includes an access path of the video source server.

To the embodiments of the present disclosure, before the Step 204, the method further includes: receiving authentication failure information sent by the control center server when the control center server detects that the authentication information of the video data is not matched with the preset authentication information; and stopping sending the acquisition request to the scheduling server. Processes of the method of embodiments of the present disclosure are terminated.

It is to be noted that before the acquisition request is sent to the scheduling server, the acquisition request is sent to the control center server to verify authentication information. The CDN server sends the acquisition request to the scheduling server when authentication success information is received. The CDN server stops sending the acquisition request to the scheduling server when authentication failure information is received. Compared with a fact that at present verification of authentication information is unavailable in the prior art, in the present disclosure, service requirements can be met, occurrence of sending invalid acquisition requests can be reduced, network pressure can be reduced, and a success rate of acquiring access path information can be improved.

205: The access path information sent by the scheduling server is received.

206: Video data in the video source server are acquired and sent to the client according to the access path information.

Further, it is convenient for the client to play the video data.

According to another method for acquiring video data provided by embodiments of the present disclosure, an acquisition request of a video source server access path sent to a scheduling server by a client is forwarded by means of a CDN server, and video data in a video source server are acquired and sent to the client at the CDN server according to access path information. Compared with a fact that at present access path information is sent to a client to acquire video data, in the present disclosure, the access path information is saved and invoked at the CDN server, which can better ensure security of address information of the video source server so that the address information of the video source server is not easily wiretapped by a Trojan horse, a third-party application or the like, thereby reducing a potential safety hazard caused to the video source server.

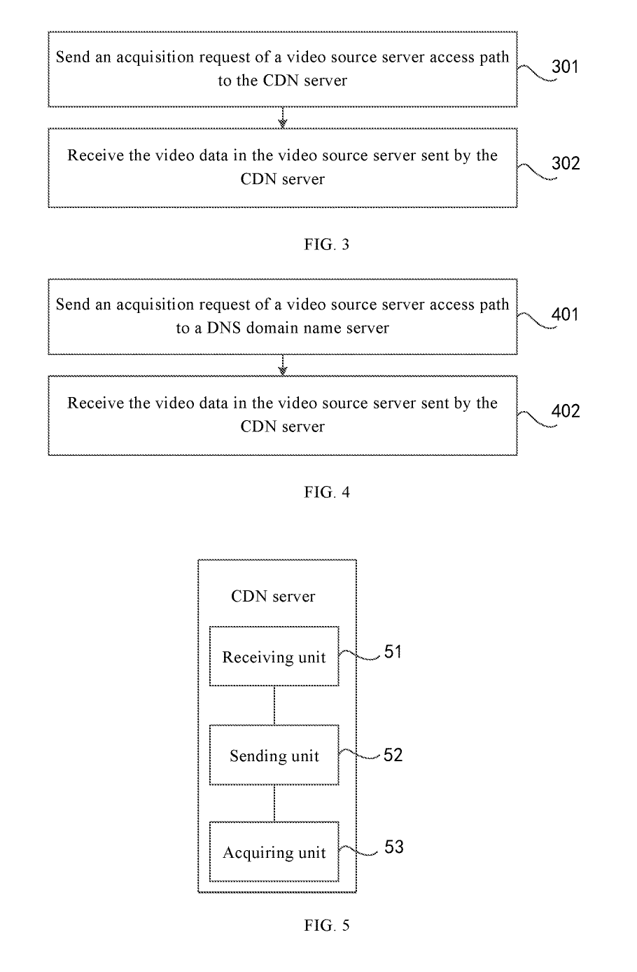

Embodiments of the present disclosure provide still another method for acquiring video data, which can be applied to a client, as shown in FIG. 3, the method includes following steps.

301: An acquisition request of a video source server access path is sent to the CDN server.

Further, the CDN server is allowed to send the acquisition request to a scheduling server so that the CDN server receives access path information, sent by the scheduling server, corresponding to the acquisition request, and acquires video data in the video source server according to the access path information. Reference can made be to corresponding description of Step 101 for an explanation of the concept of the CDN server, which is not unnecessarily elaborated any more herein. The scheduling server saves access paths of different video source servers. The access path information includes an access path of the video source server.

302: The video data in the video source server sent by the CDN server are received.

According to still another method for acquiring video data provided by embodiments of the present disclosure, an acquisition request of a video source server access path sent to a scheduling server by a client is forwarded by means of a CDN server, and video data in a video source server are acquired and sent to the client at the CDN server according to access path information. Compared with a fact that at present access path information is sent to a client to acquire video data, in the present disclosure, the access path information is saved and invoked at the CDN server, which can better ensure security of address information of the video source server so that the address information of the video source server is not easily wiretapped by a Trojan horse, a third-party application or the like, thereby reducing a potential safety hazard caused to the video source server.

Embodiments of the present disclosure provide still another method for acquiring video data, which can be applied to a client, as shown in FIG. 4, the method includes following steps.

401: An acquisition request of a video source server access path is sent to a DNS domain name server.

Further, the DNS domain name server is allowed to determine a CDN server corresponding to the client and send the acquisition request to the CDN server according to the IP address information. Specifically, according to the IP address information, a CDN server the closest to an IP address corresponding to the client can be determined, and the acquisition request can be sent to the CDN server. To the embodiments of the present disclosure, a processing efficiency of an acquisition request can be improved by sending the acquisition request to a CDN server the closest to an IP address corresponding to the client.

It is to be noted that after the CDN server receives the acquisition request, the acquisition request is sent to a scheduling server so that the CDN server receives access path information, sent by the scheduling server, corresponding to the acquisition request, and acquires video data in the video source server according to the access path information. The scheduling server saves access paths of different video source servers. The access path information includes an access path of the video source server.

To the embodiments of the present disclosure, by sending an acquisition request of a video source server access path to the DNS domain name server, the DNS domain name server also can determine a CDN server corresponding to the client and send the acquisition request to the CDN server according to currently received load status information corresponding to each CDN server. Specifically, according to load status information corresponding to each CDN server, a CDN server having the minimum load can be determined from a plurality of CDN servers, and the acquisition request can be sent to the CDN server. To the embodiments of the present disclosure, a principle of load equalization can be implemented and a processing efficiency of an acquisition request can be improved by sending the acquisition request to a CDN server having the minimum load.

402: The video data in the video source server sent by the CDN server are received.

According to still another method for acquiring video data provided by embodiments of the present disclosure, an acquisition request of a video source server access path sent to a scheduling server by a client is forwarded by means of a CDN server, and video data in a video source server are acquired and sent to the client at the CDN server according to access path information. Compared with a fact that at present access path information is sent to a client to acquire video data, in the present disclosure, the access path information is saved and invoked at the CDN server, which can better ensure security of address information of the video source server so that the address information of the video source server is not easily wiretapped by a Trojan horse, a third-party application or the like, thereby reducing a potential safety hazard caused to the video source server.

Further, as a concrete implementation of the method as shown in FIG. 1, embodiments of the present disclosure provide a CDN server, as shown in FIG. 5, the CDN server includes: a receiving unit 51, a sending unit 52 and an acquiring unit 53.

The receiving unit 51 can be configured to receive an acquisition request of a video source server access path sent by a client. The receiving unit 51 faces to the client.

The sending unit 52 can be configured to send the acquisition request received by the receiving unit 51 to a scheduling server. Facing to the scheduling server, the sending unit 52 is a main functional module sending an acquisition request to the scheduling server.

Further, the scheduling server is allowed to acquire access path information corresponding to the acquisition request.

The receiving unit 51 further can be configured to receive the access path information sent by the scheduling server. The receiving unit 51 also faces to the scheduling server.

The acquiring unit 53 can be configured to acquire video data in the video source server according to the access path information received by the receiving unit 51. The acquiring unit 53 is a main functional module for initiatively acquiring video data for the server.

The sending unit 52 further can be configured to send video data in the video source server to the client. The sending unit 52 also faces to the client.

It is to be noted that reference can be made to corresponding description in FIG. 1 for other corresponding description of various functional units involved with a CDN server provided by embodiments of the present disclosure, which is not unnecessarily elaborated any more herein. In the embodiments of the present disclosure, relevant functional modules can be implemented by means of a hardware processor.

According to a CDN server provided by embodiments of the present disclosure, an acquisition request of a video source server access path sent to a scheduling server by a client is forwarded by means of the CDN server, and video data in a video source server are acquired and sent to the client at the CDN server according to access path information. Compared with a fact that at present access path information is sent to a client to acquire video data, in the present disclosure, the access path information is saved and invoked at the CDN server, which can better ensure security of address information of the video source server so that the address information of the video source server is not easily wiretapped by a Trojan horse, a third-party application or the like, thereby reducing a potential safety hazard caused to the video source server.

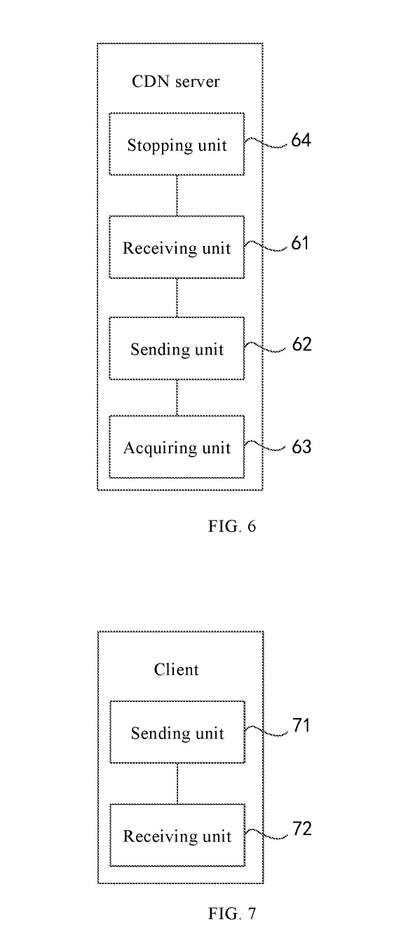

Further, as a concrete implementation of the method as shown in FIG. 2, embodiments of the present disclosure provide another CDN server, as shown in FIG. 6, the CDN server includes: a receiving unit 61, a sending unit 62 and an acquiring unit 63.

The receiving unit 61 can be configured to receive an acquisition request of a video source server access path sent by a client. The receiving unit 61 faces to the client.

The sending unit 62 can be configured to send the acquisition request received by the receiving unit 61 to a scheduling server. Facing to the scheduling server, the sending unit 62 is a main functional module sending an acquisition request to the scheduling server.

Further, the scheduling server is allowed to acquire access path information corresponding to the acquisition request.

The receiving unit 61 further can be configured to receive the access path information sent by the scheduling server. The receiving unit 61 also faces to the scheduling server.

The acquiring unit 63 can be configured to acquire video data in the video source server according to the access path information received by the receiving unit 61. The acquiring unit 63 is a main functional module for initiatively acquiring video data for the server.

The sending unit 62 further can be configured to send video data in the video source server to the client. The sending unit 62 also faces to the client.

Alternatively, the acquisition request includes authentication information of video data.

The sending unit 62 further can be configured to send the acquisition request to a control center server.

Further, the control center server is allowed to detect whether authentication information of the video data is matched with preset authentication information.

The receiving unit 61 further can be configured to receive authentication success information sent by the control center server when the control center server detects that the authentication information of the video data is matched with the preset authentication information.

The sending unit 62 specifically can be configured to send the acquisition request to the scheduling server when the authentication success information sent by the control center server is received.

Further, the CDN server further includes a stopping unit 64.

The receiving unit 61 further can be configured to receive authentication failure information sent by the control center server when the control center server detects that the authentication information of the video data is not matched with the preset authentication information.

The stopping unit 64 can be configured to stop sending the acquisition request to the scheduling server.

The receiving unit 61 specifically can be configured to receive an acquisition request of a video source server access path sent by a DNS domain name server corresponding to the client, where the DNS domain name server is configured to receive the acquisition request sent by the client and configure the CDN server corresponding to the client.

It is to be noted that reference can be made to corresponding description in FIG. 2 for other corresponding description of various functional units involved with another CDN server provided by embodiments of the present disclosure, which is not unnecessarily elaborated any more herein. In the embodiments of the present disclosure, relevant functional modules can be implemented by means of a hardware processor.

According to another CDN server provided by embodiments of the present disclosure, an acquisition request of a video source server access path sent to a scheduling server by a client is forwarded by means of the CDN server, and video data in a video source server are acquired and sent to the client at the CDN server according to access path information. Compared with a fact that at present access path information is sent to a client to acquire video data, in the present disclosure, the access path information is saved and invoked at the CDN server, which can better ensure security of address information of the video source server so that the address information of the video source server is not easily wiretapped by a Trojan horse, a third-party application or the like, thereby reducing a potential safety hazard caused to the video source server.

Further, as a concrete implementation of the method as shown in FIG. 3, embodiments of the present disclosure provide a client, as shown in FIG. 7, the client includes: a sending unit 71 and a receiving unit 72.

The sending unit 71 can be configured to send an acquisition request of a video source server access path to the CDN server. Facing to the CDN server, the sending unit 71 is a main functional module sending a request for acquiring an access path to the CDN server for the client.

Further, the CDN server is allowed to send the acquisition request to a scheduling server so that the CDN server receives access path information, sent by the scheduling server, corresponding to the acquisition request, and acquires video data in the video source server according to the access path information.

The receiving unit 72 can be configured to receive the video data in the video source server sent by the CDN server. The receiving unit 72 is a main functional module for receiving video data for the server.

It should be explained that reference can be made to corresponding description in FIG. 3 for other corresponding description of various functional units involved with a client provided by the embodiments of the present disclosure, which is not repeated any more herein. In the embodiments of the present disclosure, relevant functional modules can be implemented by means of a hardware processor.

According to a client provided by embodiments of the present disclosure, an acquisition request of a video source server access path sent to a scheduling server by the client is forwarded by means of a CDN server, and video data in a video source server are acquired and sent to the client at the CDN server according to access path information. Compared with a fact that at present access path information is sent to a client to acquire video data, in the present disclosure, the access path information is saved and invoked at the CDN server, which can better ensure security of address information of the video source server so that the address information of the video source server is not easily wiretapped by a Trojan horse, a third-party application or the like, thereby reducing a potential safety hazard caused to the video source server.

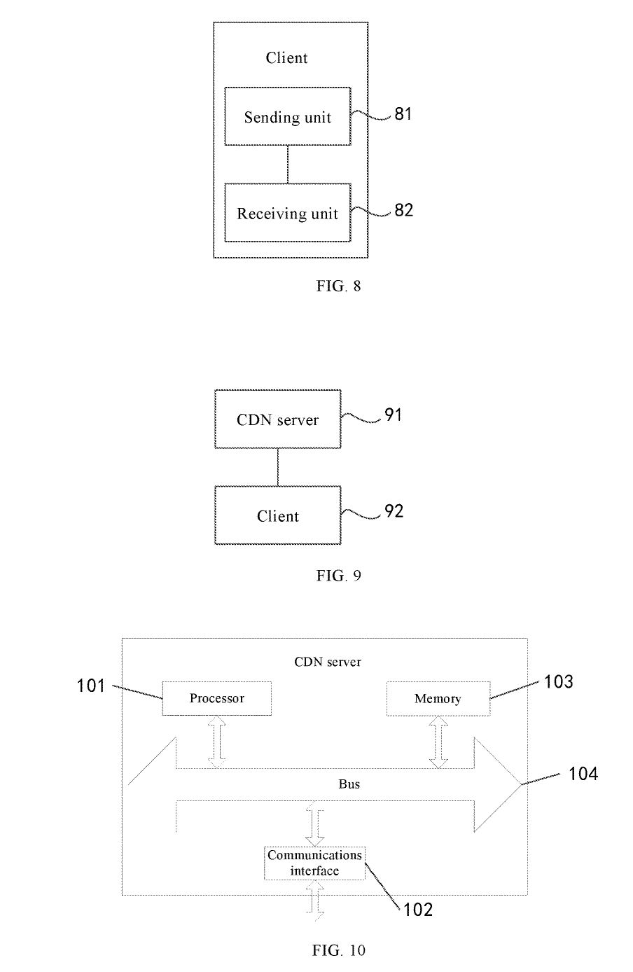

Further, as a concrete implementation of the method as shown in FIG. 4, embodiments of the present disclosure provide another client, as shown in FIG. 8, the client includes: a sending unit 81 and a receiving unit 82.

The sending unit 81 can be configured to send an acquisition request of a video source server access path to the CDN server. Facing to the CDN server, the sending unit 81 is a main functional module sending a request for acquiring an access path to the CDN server for the client.

Further, the CDN server is allowed to send the acquisition request to a scheduling server so that the CDN server receives access path information, sent by the scheduling server, corresponding to the acquisition request, and acquires video data in the video source server according to the access path information.

The receiving unit 82 is configured to receive the video data in the video source server sent by the CDN server. The receiving unit 82 is a main functional module for receiving video data for the server.

Alternatively, the acquisition request includes IP address information corresponding to the client.

The sending unit 81 specifically can be configured to send an acquisition request of a video source server access path to a DNS domain name server.

Further, the DNS domain name server is allowed to determine a CDN server corresponding to the client and send the acquisition request to the CDN server according to the IP address information.

The sending unit 81 further specifically can be configured to send an acquisition request of a video source server access path to the DNS domain name server.

Further, the DNS domain name server is allowed to determine a CDN server corresponding to the client and send the acquisition request to the CDN server according to currently received load status information corresponding to each CDN server.

It should be explained that reference can be made to corresponding description in FIG. 4 for other corresponding description of various functional units involved with another client provided by the embodiments of the present disclosure, which is not repeated any more herein. In the embodiments of the present disclosure, relevant functional modules can be implemented by means of a hardware processor.

According to another client provided by embodiments of the present disclosure, an acquisition request of a video source server access path sent to a scheduling server by the client is forwarded by means of a CDN server, and video data in a video source server are acquired and sent to the client at the CDN server according to access path information. Compared with a fact that at present access path information is sent to a client to acquire video data, in the present disclosure, the access path information is saved and invoked at the CDN server, which can better ensure security of address information of the video source server so that the address information of the video source server is not easily wiretapped by a Trojan horse, a third-party application or the like, thereby reducing a potential safety hazard caused to the video source server.

Further, embodiments of the present disclosure provide a system for acquiring video data, including a CDN server 91 and a client 92.

The client 92 can be configured to send an acquisition request of a video source server access path to the CDN server 91.

The CDN server 91 can be configured to receive an acquisition request of a video source server access path sent by the client 92, send the acquisition request to a scheduling server so that the scheduling server acquires access path information corresponding to the acquisition request, receive the access path information sent by the scheduling server, and acquire and send video data in the video source server to the client 92 according to the access path information.

The client 92 further can be configured to receive the video data in the video source server sent by the server.

Exemplarily, as shown in FIG. 10, which illustrates a schematic diagram of an entity structure of a CDN server according to embodiments of the present disclosure, the CDN server can include: a processor 101, a communications interface 102, a memory 103 and a bus 104, where the processor 101, the communications interface 102 and the memory 103 complete communications among each other through the bus 104. The communications interface 102 can be configured to implement information transmission between the server and the client. The processor 101 can invoke a logic instruction in the memory 103 to execute the following method: the CDN server receives an acquisition request of a video source server access path sent by the client, sends the acquisition request to a scheduling server so that the scheduling server acquires access path information corresponding to the acquisition request, receives the access path information sent by the scheduling server, and acquires and sends video data in the video source server to the client according to the access path information. In addition, when a logic instruction in the foregoing memory 103 can be implemented in the form of a software functional unit and is sold or used as an independent product, the logic instruction can be stored in a computer-readable storage medium. Based on such understanding, the essence of or a part of the technical solutions in the present disclosure (that is, the part making contributions over prior arts) may be embodied as software products. The computer software products may be stored in a storage medium including instructions which enable a computer device (for example, a personal computer, a server or a network device, and so on) to perform whole or a part of the steps in the methods according to various embodiments of the present disclosure. The above mentioned storage medium may include various mediums capable of storing program codes, for example, a USB flash drive, a mobile hard disk drive, a read only memory (ROM), a random access memory (RAM), a magnetic disk or an optical disk, and so on.

According to a system for acquiring video data provided by embodiments of the present disclosure, an acquisition request of a video source server access path sent to a scheduling server by a client is forwarded by means of a CDN server, and video data in a video source server are acquired and sent to the client at the CDN server according to access path. Compared with a fact that at present access path information is sent to a client to acquire video data, in the present disclosure, the access path information is saved and invoked at the CDN server, which can better ensure security of address information of the video source server so that the address information of the video source server is not easily wiretapped by a Trojan horse, a third-party application or the like, thereby reducing a potential safety hazard caused to the video source server.

Further, an embodiment of the present disclosure further provides a non-transitory computer-readable storage medium storing executable instructions, which can be executed by an electronic device to perform any methods for acquiring video data mentioned by embodiments of the present disclosure.

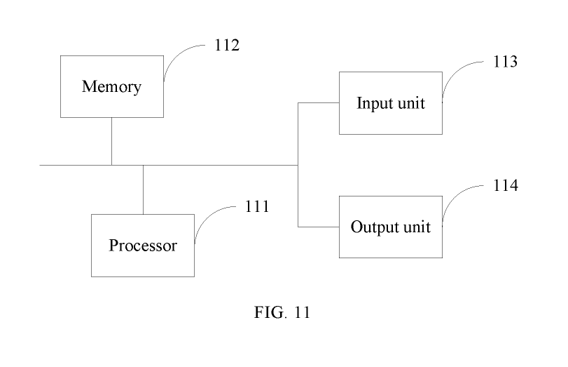

FIG. 11 is a block diagram of an electronic device which is configured to perform the methods for acquiring video data according to an embodiment of the present disclosure. As shown in FIG. 11, the device includes:

one or more processors 111 and memory 112. A processor 111 is showed in FIG. 11 for an example.

Device which is configured to perform the methods for acquiring video data can also include: input unit 113 and output unit 114.

Processor 111, memory 112, input unit 113 and output unit 114 can be connected by BUS or other methods, and BUS connecting is showed in FIG. 11 for an example.

Memory 112 can be used for storing non-transitory software program, non-transitory computer executable program and modules as a non-transitory computer-readable storage medium, such as corresponding program instructions/modules for the methods for acquiring video data mentioned by embodiments of the present disclosure (such as shown in FIG. 5, receiving unit 51, sending unit 52 and acquiring unit 53). Processor 111 performs kinds of functions and acquiring video data of the electronic device by executing non-transitory software program, instructions and modules which are stored in memory 112, thereby realizes the methods for acquiring video data mentioned by embodiments of the present disclosure.

Memory 112 can include program storage area and data storage area, thereby the operating system and applications required by at least one function can be stored in program storage area and data created by using the device for acquiring video data can be stored in data storage area. Furthermore, memory 112 can include high speed Random-access memory (RAM) or non-volatile memory such as magnetic disk storage device, flash memory device or other non-volatile solid state storage devices. In some embodiments, memory 112 can include long-distance setup memories relative to processor 111, which can communicate with the device for acquiring video data by networks. The examples of said networks are including but not limited to Internet, Intranet, LAN, mobile Internet and their combinations.

Input unit 113 can be used to receive inputted number, character information and key signals causing user configures and function controls of the device for acquiring video data. Output unit 114 can include a display screen or a display device.

The said module or modules are stored in memory 112 and perform the methods for acquiring video data when executed by one or more processors 111.

The said device can reach the corresponding advantages by including the function modules or performing the methods provided by embodiments of the present disclosure. Those methods can be referenced for technical details which may not be completely described in this embodiment.

Electronic devices in embodiments of the present disclosure can be existences with different types, which are including but not limited to:

(1) Mobile Internet devices: devices with mobile communication functions and providing voice or data communication services, which include smartphones (e.g. iPhone), multimedia phones, feature phones and low-cost phones.

(2) Super mobile personal computing devices: devices belong to category of personal computers but mobile internet function is provided, which include PAD, MID and UMPC devices, e.g. iPad.

(3) Portable recreational devices: devices with multimedia displaying or playing functions, which include audio or video players, handheld game players, e-book readers, intelligent toys and vehicle navigation devices.

(4) Servers: devices with computing functions, which are constructed by processors, hard disks, memories, system BUS, etc. For providing services with high reliabilities, servers always have higher requirements in processing ability, stability, reliability, security, expandability, manageability, etc., although they have a similar architecture with common computers.

(5) Other electronic devices with data interacting functions.

The embodiments of devices are described above only for illustrative purposes. Units described as separated portions may be or may not be physically separated, and the portions shown as respective units may be or may not be physical units, i.e., the portions may be located at one place, or may be distributed over a plurality of network units. A part or whole of the modules may be selected to realize the objectives of the embodiments of the present disclosure according to actual requirements.

In view of the above descriptions of embodiments, those skilled in this art can well understand that the embodiments can be realized by software plus necessary hardware platform, or may be realized by hardware. Based on such understanding, it can be seen that the essence of the technical solutions in the present disclosure (that is, the part making contributions over prior arts) may be embodied as software products. The computer software products may be stored in a computer readable storage medium including instructions, such as ROM/RAM, a magnetic disk, an optical disk, to enable a computer device (for example, a personal computer, a server or a network device, and so on) to perform the methods of all or a part of the embodiments.

It shall be noted that the above embodiments are disclosed to explain technical solutions of the present disclosure, but not for limiting purposes. While the present disclosure has been described in detail with reference to the above embodiments, those skilled in this art shall understand that the technical solutions in the above embodiments can be modified, or a part of technical features can be equivalently substituted, and such modifications or substitutions will not make the essence of the technical solutions depart from the spirit or scope of the technical solutions of various embodiments in the present disclosure.

What is claimed is:

1. A method for acquiring video data, implemented by a content distribution network (CDN) server, comprising:
receiving, by a CDN server, an acquisition request of a video source server access path sent by a client;
sending the acquisition request to a scheduling server so that the scheduling server acquires access path information corresponding to the acquisition request;
receiving the access path information sent by the scheduling server; and
acquiring and sending video data in the video source server to the client according to the access path information.

2. The method for acquiring video data according to claim 1, wherein the acquisition request comprises authentication information of video data;
before sending the acquisition request to a scheduling server, the method further comprises:
sending the acquisition request to a control center server so that the control center server detects whether the authentication information of the video data is matched with preset authentication information; and
receiving authentication success information sent by the control center server when the control center server detects that the authentication information of the video data is matched with the preset authentication information; and
the sending the acquisition request to a scheduling server comprises:
sending the acquisition request to the scheduling server when the authentication success information sent by the control center server is received.

3. The method for acquiring video data according to claim 2, wherein the method further comprises:
receiving authentication failure information sent by the control center server when the control center server detects that the authentication information of the video data is not matched with the preset authentication information; and
stopping sending the acquisition request to the scheduling server.

4. The method for acquiring video data according to claim 1, wherein the receiving, by a CDN server, an acquisition request of a video source server access path sent by a client comprises:
receiving, by the CDN server, an acquisition request of a video source server access path sent by a domain name system DNS domain name server corresponding to the client, wherein the DNS domain name server is configured to receive the acquisition request sent by the client and configure the CDN server corresponding to the client.

5. A non-transitory computer-readable storage medium storing executable instructions, wherein the executable instructions are configured to:
receive an acquisition request of a video source server access path sent by a client;
send the acquisition request to a scheduling server so that the scheduling server acquires access path information corresponding to the acquisition request;
receive the access path information sent by the scheduling server; and
acquire and send video data in the video source server to the client according to the access path information.

6. The non-transitory computer-readable storage medium according to claim 5, wherein the acquisition request comprises authentication information of video data;
before sending the acquisition request to a scheduling server, the executable instructions are further configured to:
send the acquisition request to a control center server so that the control center server detects whether the authentication information of the video data is matched with preset authentication information; and
receive authentication success information sent by the control center server when the control center server detects that the authentication information of the video data is matched with the preset authentication information; and
the sending the acquisition request to a scheduling server comprises:
sending the acquisition request to the scheduling server when the authentication success information sent by the control center server is received.

7. The non-transitory computer-readable storage medium according to claim 6, wherein the executable instructions are further configured to:
receive authentication failure information sent by the control center server when the control center server detects that the authentication information of the video data is not matched with the preset authentication information; and
stop sending the acquisition request to the scheduling server.

8. The non-transitory computer-readable storage medium according to claim 5, wherein the receiving an acquisition request of a video source server access path sent by a client comprises:
receiving an acquisition request of a video source server access path sent by a domain name system DNS domain name server corresponding to the client, wherein the DNS domain name server is configured to receive the acquisition request sent by the client and configure a CDN server corresponding to the client.

9. An electronic device, comprising:
at least one processor; and
a memory communicably connected with the at least one processor for storing instructions executable by the at least one processor, wherein execution of the instructions by the at least one processor causes the at least one processor to:
receive an acquisition request of a video source server access path sent by a client;
send the acquisition request to a scheduling server so that the scheduling server acquires access path information corresponding to the acquisition request;
receive the access path information sent by the scheduling server; and
acquire and send video data in the video source server to the client according to the access path information.

10. The electronic device according to claim 9, wherein the acquisition request comprises authentication information of video data;
before sending the acquisition request to a scheduling server, the instructions are executed to cause the at least one processor to:
send the acquisition request to a control center server so that the control center server detects whether the authentication information of the video data is matched with preset authentication information; and
receive authentication success information sent by the control center server when the control center server detects that the authentication information of the video data is matched with the preset authentication information; and
the sending the acquisition request to a scheduling server comprises:
sending the acquisition request to the scheduling server when the authentication success information sent by the control center server is received.

11. The electronic device according to claim 10, wherein the instructions are executed to cause the at least one processor to:
receive authentication failure information sent by the control center server when the control center server detects that the authentication information of the video data is not matched with the preset authentication information; and
stop sending the acquisition request to the scheduling server.

12. The electronic device according to claim 9, wherein the receiving an acquisition request of a video source server access path sent by a client comprises:
receiving an acquisition request of a video source server access path sent by a domain name system DNS domain name server corresponding to the client, wherein the DNS domain name server is configured to receive the acquisition request sent by the client and configure a CDN server corresponding to the client.
